(19) United States
(12) Patent Application Publication
(10) Pub. No.: US 2010/0074151 A1
(43) Pub. Date: Mar. 25, 2010

(54) METHOD AND SYSTEM FOR REDUCING ADJACENT CHANNEL INTERFERENCE USING TIME DIVISION DUPLEX (TDD)

(75) Inventors: Erik Westerberg, Enskede (SE); Krister Sundberg, Sollentuna (SE)

Correspondence Address: HARRITY & HARRITY, LLP, 11350 RANDOM HILLS RD., SUITE 600, FAIRFAX, VA, 22030, US

(73) Assignee: TELEFONAKTIEBOLAGET LM ERICSSON (PUBL), Stockholm (SE)

(21) Appl. No.: 12/443,353

(22) PCT Filed: Sep. 29, 2006
(86) PCT No.: PCT/SE06/50363

§ 371 Date: Mar. 27, 2009

(51) Int. Cl. H04J 3/00; H04B 15/00; H04L 27/28

(52) U.S. Cl. 370/280; 455/63.1; 375/260

(57) ABSTRACT

The present invention relates to communications systems comprising time division duplex, TDD, technologies, and more especially it relates to allocation of uplink and downlink communications in such communications systems in an orthogonal domain, such as frequency domain.

### TECHNICAL FIELD

The present invention relates to communications systems comprising time division duplex, TDD, technologies, and more especially it relates to allocation of uplink and downlink communications in such communications systems. Particularly, it relates to allocation of communications in such systems in an orthogonal domain, such as frequency domain.

### BACKGROUND

Time division duplex systems are receiving an increasing interest due to its relieved requirement on paired spectrum, required for frequency division duplex, FDD, systems. With limited frequency spectrum being a limited nature resource, TDD allows use of a single frequency band for both uplink and downlink communications. The single band requirement simplifies frequency licensing to various operators.

Orthogonal Frequency Division Multiplex, OFDM, radio interface systems, e.g. WiMAX, uses a plurality of frequencies separated in frequency domain such that they do not correlate. The frequencies are said to be orthogonal.

Ericsson, ‘WiMAX—Copper in the Air’, White Paper, April 2006, discusses in Chapter 4 the WiMAX OFDM and OFDMA (Orthogonal Frequency Division Multiple Access) radio interfaces. A challenge of the OFDM technology is the large ratio of peak power to average power. The White Paper claims it to be an advantage of WiMAX that it can operate in either Time Division Duplex (TDD) or Frequency Division Duplex (FDD) mode.

Gábor Fodor: ‘Performance Analysis of a Reuse Partitioning Technique for OFDM Based Evolved UTRA,’ Fourteenth IEEE International Workshop on Quality of Service (IWQoS 2006), Jun. 19-21, 2006, USA, proposes and analyzes a simple reuse partitioning technique (assuming coordinated sub-carrier allocation in the cells) claimed to be capable of minimizing inter-cell interference. System performance of OFDMA based systems in terms of sub-carrier collisions, session blocking probabilities and signal-to-noise-and-interference ratio is presented with numerical results.

Erik Dahlman, Hannes Ekström, Anders Furuskär, Jonas Karlsson, Michael Meyer, Stefan Parkvall, Johan Torsner and Mattias Wahlqvist, ‘The Long-Term Evolution of 3G,’ Ericsson Review No. 2, 2005, describes technologies that promise to provide improved service provisioning and reduce user and operator costs. The described technologies include orthogonal frequency-division multiplexing, OFDM, single-carrier FDMA with dynamic bandwidth, SC-FDMA, multi-antenna solutions, evolved quality of service and link-layer concepts, and evolved system architecture. OFDM with frequency-domain adaptation, AML-OFDM (Adaptive Multilayer OFDM), is considered for downlink transmissions due to its support of high data rates and potentially flexible spectrum allocation. By varying the number of AML-OFDM sub-carriers, different allocations of spectrum ranging from 1.25 MHz to 20 MHz are supported. The fine frequency granularity offered by AML-OFDM facilitates smooth migration, e.g., of 2G spectrum. In principle, a GSM operator may migrate on a carrier-by-carrier (for GSM 200 kHz wide) basis using only a fraction of available OFDM sub-carriers. Also mentioned is AML-OFDM support of time-division and frequency-division duplex operation. Single-carrier Frequency Division Multiple Access, SC-FDMA, with dynamic bandwidth is preferred for uplink transmissions due to its power efficiency. Each base station of a cellular radio communication system assigns terminals a unique frequency for transmitting user data and ensuring intra-cell orthogonality, thus avoiding intra-cell interference. Most of the time, time-domain scheduling is used to separate users. Frequency-domain scheduling is used for terminals with limited power or little data to transmit. With limited transmission power mobile terminals cannot transmit a pilot signal covering an entire frequency band continuously. Because of limited knowledge of uplink channel conditions, frequency-domain adaptation is usually not used in the uplink. Slow power control is used to compensate for path loss and shadow fading. Thanks to the orthogonality of uplink transmissions, there is no need for fast power control to handle any near-far problem. Interference due to multipath propagation is handled at the base station, aided by insertion of a cyclic prefix in the transmitted signal. The transmission parameters, coding and modulation are similar to those of the downlink transmissions. FIG. 1 illustrates schematically a radio communications system, but is essentially applicable to any wireless communications system. An enhanced Gateway GPRS (Global Packet Radio Services) Support Node, GSN+, is a gateway anchor node in the home network. Central anchor nodes <<Central Anchor 1>>, <<Central Anchor 2.>> ensure mobility, security and transport network efficiency and are anchor nodes in a visited network. The anchor nodes <<Central Anchor 1>>, <<Central Anchor 2>> control base stations <<Node B₁>>, <<Node B₂>>, <<Node 3₃>>, <<Node B₄>> interconnecting wireless user equipment <<UE>>.

U.S. Pat. No. 7,099,377 demonstrates a WCDMA-TDD system. A scrambling code which is a long pseudo noise code sequence, is associated with each base station and permits to distinguish the base stations from each other.

Further, an orthogonal variable spreading factor code, OVSF code, is allocated to each remote terminal (such as cellular mobile phone). All these OVSF codes are orthogonal to each other, which permits to distinguish a remote terminal from another.

A problem inherent with TDD communications is its sensitivity to interference between uplink and downlink communications. Particularly, this is a problem if the downlink and uplink communications are controlled by different operators running their networks, the networks not being synchronized. A main reason for this interference being a problem is the different distances between transmitters. If a nearby interfering user transmits in uplink direction, downlink communications received by an interfered user are generally of a substantially smaller received signal level than the interference received from the nearby interfering user, thereby destroying downlink reception.

In prior art, the abovementioned interference problem is generally solved by separating the various frequency bands, used by different operators, by allocating particular guard bands in frequency domain, thereby reducing or eliminating the interference between the different bands of communication including interference between uplink communications of one operator with downlink communications of another.

The allocation of frequency guard bands is schematically illustrated in FIG. 2. In the figure, frequencies are grouped in blocks <<A1>>, <<A2>>, <<A3>>, <<B1>>, <<B2>>, <<B3>> allocated to two different operators <<A>>, <<B>>. In the figure, two of the groups <<A1>>, <<B1>> form a guard band. Of course, the guard band needs not be allocated to particular one or more operators. The bands used for communications <<A2>>, <<A3>>, <<B2>>, <<B3>> are used for communications in both uplink and downlink directions.

An apparent problem of the prior art guard band allocation is the waste of useful frequency bands, unless they by chance can be applied for a non-interfering application or technology, such as some low-power application of very limited range.

None of the cited documents above discloses a method and system of allocating a fraction of available frequency range to uni-directional usage in a domain orthogonal to the TDD domain in radio communications.

### SUMMARY

Dividing frequency band to be used partly for uni-directional communications only, e.g. downlink communications, and partly for bi-directional communications eliminates or reduces substantially the risk of interference between communications in downlink and uplink directions and enables control of interference between two operators using the uni-directional part of the band for communications in one direction within allocated fractions of the uni-directional part of the band.

Thereby, the use of guard bands in order to reduce or eliminate cross-direction interference can be eliminated and a limited nature resource be more efficiently used.

This is achieved by a method and system of two-dimensional separation, such as TDD and frequency domain separation, wherein transmitting entities communicating in a direction which may interfere with another communicating entity in transmitting in another direction are separated in both dimensions.

Preferred embodiments of the invention, by way of examples, are described with reference to the accompanying drawings below.

### BRIEF DESCRIPTION OF THE DRAWINGS

FIG. 1 illustrates schematically a radio communications system according to prior art.

FIG. 2 illustrates allocation of frequency guard bands in an example TDD system according to prior art.

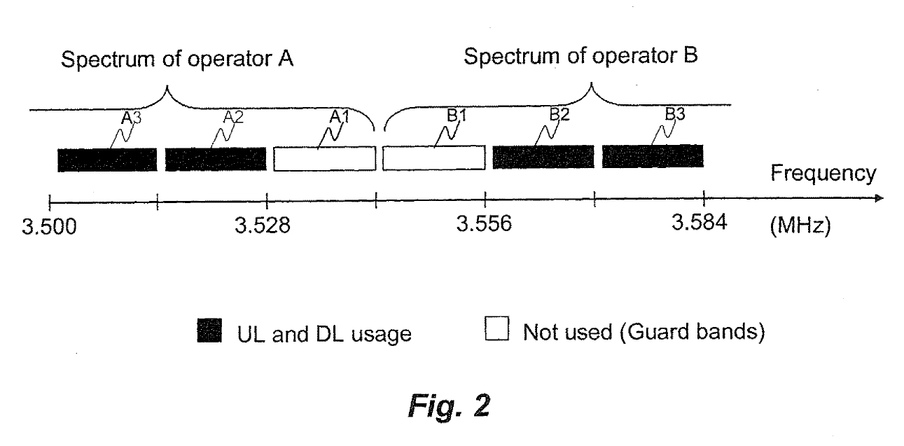

FIG. 3 demonstrates schematically frequency bands allocated to uni-directional communications according to the invention.

FIG. 4 illustrates an anchor node comprising processing means adapted to the invention.

FIG. 5 illustrates example allocation of downlink and uplink frames according to the invention.

### DETAILED DESCRIPTION

In the following description, for purpose of explanation, specific details are set forth such as particular architectures, interfaces, techniques, etc. in order to provide a thorough understanding of the present invention. However, it will be apparent to those skilled in the art that the present invention may be practiced in other embodiments that depart from these specific details.

In some instances, detailed descriptions of well-known devices, circuits, and methods are omitted so as not to obscure the description of the present invention with unnecessary detail. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

According to the invention, an orthogonalizing technique, e.g. frequency division multiplex, FDM, is preferably used as a basis for using a frequency band or other orthogonal domain range for one-way direction communications. In the frequency domain preferably OFDMA or SC-FDMA are applied for channel access. By using scheduling of opportunities, it is possible to avoid using, e.g., the upper or lower part of the carriers for uplink traffic. In most consumer oriented systems, downlink traffic often requires greater capacity, or bandwidth, than uplink traffic. This is typically the case for web-browsing, reception of mobile TV, reception of streaming media, file downloads etc. For consumer oriented systems, bandwidth allocation according to the preferred embodiment, thereby, is a further means to provide the additional downlink capacity while limiting or eliminating interference, and thereby further improves system performance.

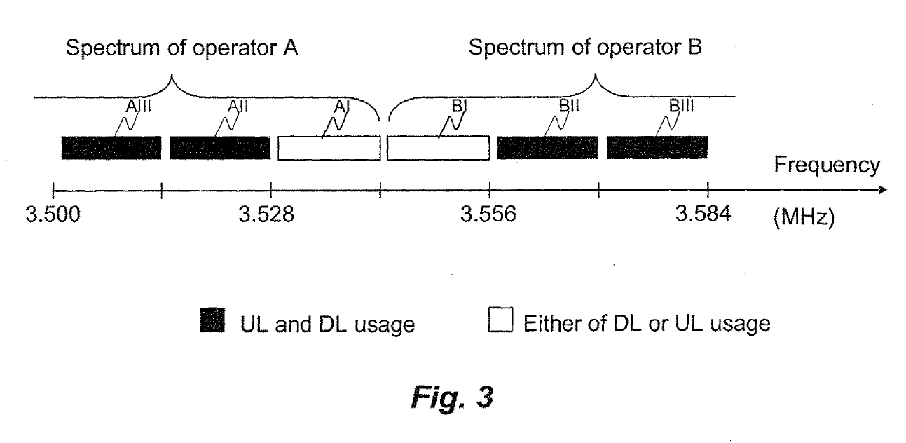

FIG. 3 illustrates schematically a TDD carrier which in effect can be specified using FDD terminology. Data blocks sent on frequencies well separated in frequency domain between different operators <<AII>>, <<AIII>>, <<BII,>>, <<BIII>> can be used for bi-directional communications or uplink communications and adjacent frequencies of the two operators <<AI>>, <<BI>> are used for downlink communications. The example frequency range between 3500 and 3584 MHz is just an example and does not limit the invention.

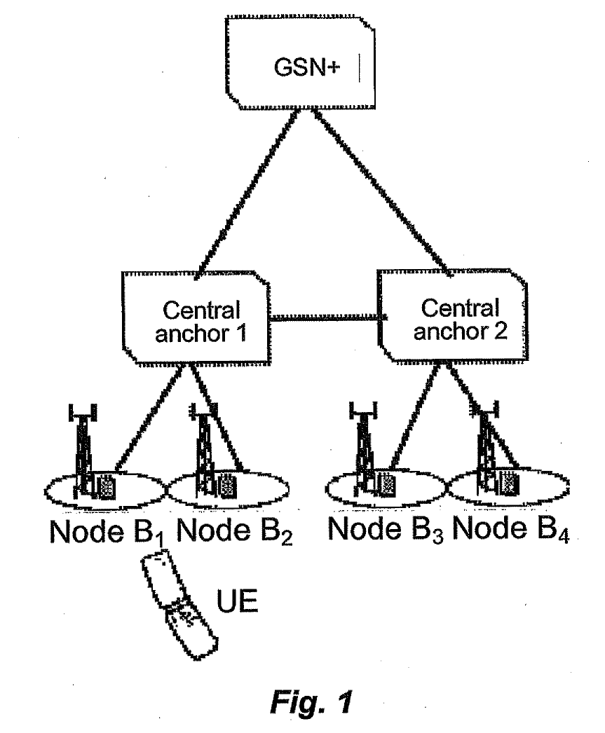

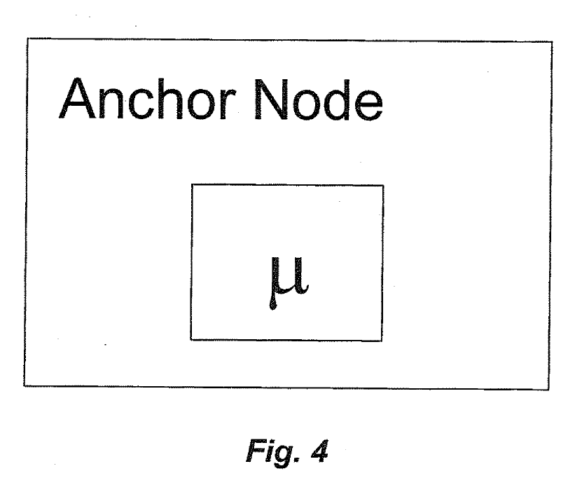

According to a preferred mode of the invention, each mobile station is dynamically scheduled on different points in the orthogonal domain, e.g. onto different frequency components, also called tones, for OFDM forming the orthogonal domain for various transmission instants. For OFDM, a mobile station is generally scheduled for a plurality of tones for each transmission instant. This holds for both uplink and downlink transmissions in general. Some downlink transmissions, e.g. due to bandwidth requirements or availability, are allocated a particular downlink frequency band with downlink transmissions in only one direction. With system architecture similar to the architecture in FIG. 1, processing means of the central anchor nodes <<Central Anchor>> are preferably adapted for channel allocation in accordance with the invention. The invention is of value also if not all anchor nodes of a communications system implement the invention. However, the risk of interference then increases unless anchor nodes not implementing the invention reserve guard bands in accordance with prior art. FIG. 4 illustrates in principle processing means <<μ>> of an anchor node <<anchor node>>, the processing means being particularly adapted to the invention, e.g., by means of an installed computer program product allocating channels as described above.

Also according to a preferred mode of the invention, the frame structure of uplink and downlink transmissions is maintained similar to a system not implementing the invention with a particular one-directional orthogonal dimension, e.g. a particular downlink frequency band, of a TDD system. Consequently, no uplink frames are scheduled for the particular downlink frequency band in the example with such a particular frequency band.

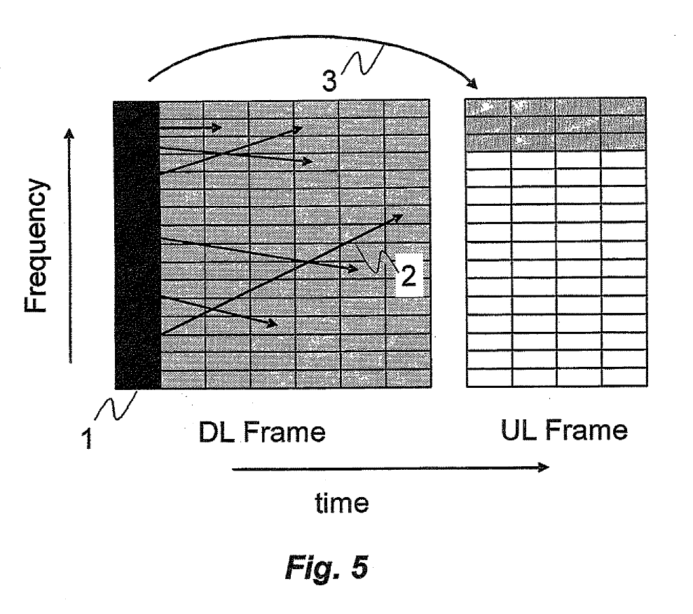

FIG. 5 illustrates example allocation of downlink and uplink frames according to the invention. Scheduling information is preferably provided in the beginning of a downlink frame. The scheduling information indicates which one or more frequencies are allocated to each user during a particular time interval. For a subsequent uplink frame, the scheduling information provided in the downlink frame also indicates to a mobile station or user equipment which frequencies are exclusively reserved for downlink transmission and should not be used for uplink transmissions.

A person skilled in the art readily understands that the receiver and transmitter properties of, e.g., a user equipment are general in nature. The use of concepts such as user equipment, UE, adaptive multilayer, AML, WiMAX or WCDMA within this patent application is not intended to limit the invention only to devices associated with these acronyms. It concerns all devices operating correspondingly, or being obvious to adapt thereto by a person skilled in the art, in relation to the invention.

The invention is not intended to be limited only to the embodiments described in detail above. Changes and modifications may be made without departing from the invention. It covers all modifications within the scope of the following claims.

1. A method of multi-domain allocation of communications in a wireless communications system, the wireless communications system comprising one or more base stations and user equipment, the wireless communications system interconnecting, as requested, base stations and user equipment for communications, the method comprising:
allocating, in a domain orthogonal to the time domain, time domain duplex communications in a single direction to/from one or more base stations from/to user equipment of the wireless communications system in a particular range of the domain orthogonal to the time domain, and
allocating time domain duplex communications in both directions between the one or more base stations and user equipment of the wireless communications system in another range of the domain orthogonal to the time domain.

2. The method in claim 1 where the single direction is a downlink direction.

3. The method in claim 1 where the interconnections are allocated by a control node connecting two or more base stations.

4. The method in claim 1 where the domain orthogonal to the time domain is a frequency domain.

5. The method in claim 4 where the frequency domain is subject to orthogonal frequency division multiplex.

6. The method in claim 5 the where an access method of the frequency domain is an orthogonal frequency division multiple access.

7. The method in claim 4 the where an access method of the frequency domain is a single carrier frequency division multiple access.

8. A node for multi-domain allocation of communications in a wireless communications system, the wireless communications system comprising one or more base stations and user equipment, the wireless communications system interconnecting, as requested, base stations and user equipment for communications, the node comprising:
means for determining allocation information, the allocation information providing information for channel allocation in a domain orthogonal to the time domain;
where the allocation information causes time domain duplex communications to be provided in a single direction, to/from one or more base stations from/to user equipment of the wireless communications system, and in a particular range of the domain orthogonal to the time domain, and time domain duplex communications to be provided in both directions between the one or more base stations and user equipment of the wireless communications system and in another range of the domain orthogonal to the time domain; and
means for providing the allocation information.

9. The node in claim 8 where the allocation information is transmitted in direction from base station to user equipment.

10. The node in claim 8 where the allocation information concerns channel allocation for one or more transmissions in an uplink direction.

11. The node in claim 8 where the single direction is a downlink direction.

12. The node in claim 8 where the allocation information is transmitted in a time division duplex frame structure.

13. A node of a wireless communications system arranged for multi-domain allocation of communications in the wireless communications system, the wireless communications system interconnecting, as requested, one or more base stations and user equipment of the system for communications, the node comprising:
means for allocating, in a domain orthogonal to the time domain, time domain duplex communications in a single direction to/from one or more base stations from/to user equipment of the wireless communications system in a particular range of the domain orthogonal to the time domain, and
means for allocating time domain duplex communications in both directions, between the one or more base stations and user equipment of the wireless communications system, in another range of the domain orthogonal to the time domain.

14. The node of a wireless communications system in claim 13 where the single direction is a downlink direction.

15. The node of a wireless communications system in claim 13 where the node is connected to two or more base stations.

16. The node in claim 13 where the domain orthogonal to the time domain is a frequency domain.

17. The node in claim 16 where the frequency domain is subject to orthogonal frequency division multiplex.

18. The node in claim 17 where an access method of the frequency domain is an orthogonal frequency division multiple access.

19. The node in claim 16 where an access method of the frequency domain is a single carrier frequency division multiple access.

20. A radio communications system comprising one or more user terminals, one or more radio base stations and one or more control nodes, the one or more control nodes comprising:
means for allocating, in a domain orthogonal to the time domain, time domain duplex communications in a single direction to/from the one or more base stations from/to the one or more user terminals of the radio communications system in a particular range of the domain orthogonal to the time domain; and
means for allocating time domain duplex communications in both directions between the one or more base stations and the one or more user terminals of the radio communications system in another range of the domain orthogonal to the time domain.
